(19) United States
(12) Patent Application Publication
(10) Pub. No.: US 2014/0278745 A1
(43) Pub. Date: Sep. 18, 2014

(54) SYSTEMS AND METHODS FOR PROVIDING RETAIL PROCESS ANALYTICS INFORMATION BASED ON PHYSIOLOGICAL INDICATOR DATA

(71) Applicant: TOSHIBA GLOBAL COMMERCE SOLUTIONS HOLDINGS CORPORATION, Research Triangle Park, NC (US)

(72) Inventors: Dean F. Herring, Youngsville, NC (US); Brad M. Johnson, Raleigh, NC (US); Jeffrey J. Smith, Raleigh, NC (US); Adrian X. Rodriguez, Durham, NC (US)

(73) Assignee: Toshiba Global Commerce Solutions Holdings Corporation, Research Triangle Park, NC (US)

(21) Appl. No.: 13/835,033

(22) Filed: Mar. 15, 2013

(51) Int. Cl. G06Q 30/02

(52) U.S. Cl. CPC G06Q 30/0201
USPC 705/7.29

(57) ABSTRACT

Systems and methods for providing retail process analytics information based on physiological indicator data are disclosed herein. According to an aspect, a method may include using a processor and memory for receiving physiological indicator data associated with a person. The processor and memory may also be used for determining a retail environment condition at a time associated with the physiological indicator data. Further, the processor and memory may be used for generating retail process analytics information for user presentation based on the physiological indicator data and the retail environment condition.

### BACKGROUND

1. Field of the Invention

The present invention relates to retail process analytics, and more specifically, to providing retail process analytics information based on physiological indicator data.

2. Description of Related Art

In retail environments, such as grocery stores and other “brick and mortar” stores, customers and retail personnel frequently interact with each another. Most typically, for example, a customer will interact with a checkout attendant when the customer is ready to purchase products. In another example, retail personnel may converse with a customer to provide information about a product or to direct the customer to the location of a product within a store. In another example, a salesperson may converse with a customer in an attempt to sell a product to the customer. These types of interactions and others can be very important to the satisfaction of customers, and thus the success of retailers. In addition, optimization of such interactions can improve the morale and job satisfaction of retail personnel. For at least these reasons, it is desired to optimize interactions among customers and retail personnel and to provide analytics information to retailers based on such interactions.

### BRIEF SUMMARY

Systems and methods for providing retail process analytics information based on physiological indicator data are disclosed herein. According to an aspect, a method may include using a processor and memory for receiving physiological indicator data associated with a person. The processor and memory may also be used for determining a retail environment condition at a time associated with the physiological indicator data. Further, the processor and memory may be used for generating retail process analytics information for user presentation based on the physiological indicator data and the retail environment condition.

According to another aspect, a method may include using a processor and memory for determining physiological indicator data associated with an interaction between a customer and retail personnel within a retail environment. The processor and memory may also be used for generating retail process analytics information for user presentation based on the physiological indicator data.

According to another aspect, a method may include using a processor and memory for determining physiological indicator data associated with an interaction between a customer and an advertisement within a retail environment. The processor and memory may also be used for generating retail process analytics information for user presentation based on the physiological indicator data.

### BRIEF DESCRIPTION OF THE SEVERAL VIEWS OF THE DRAWINGS

FIG. 1 is a block diagram of a purchase transaction system 100 according to embodiments of the present invention;

FIG. 2 is a flowchart of an example method for providing retail process analytics information based on physiological indicator data in accordance with embodiments of the present invention;

FIG. 3 is a flowchart of another example method for providing retail process analytics information based on physiological indicator data in accordance with embodiments of the present invention;

FIG. 4 is a flowchart of another example method for providing retail process analytics information based on physiological indicator data in accordance with embodiments of the present invention; and

FIG. 5 is a flowchart of another example method for providing retail process analytics information based on physiological indicator data in accordance with embodiments of the present invention.

### DETAILED DESCRIPTION

Disclosed herein are systems and methods for providing retail process analytics information based on physiological indicator data. In accordance with embodiments of the present invention, a method may be implemented by one or more computing devices located within a retail environment. Alternatively, a subset of the computing devices implementing the disclosed methods may be located within the retail environment, while other computing devices that implement other parts of the method may be located outside of the retail environment. For example, client computing devices operating within the retail environment may operate together with a remote server for implementing methods disclosed herein.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, a server or other computer located within a retail environment and communicatively connected to other computing devices (e.g., point-of-sale (POS) equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

As referred to herein, the term “physiological indicator data” is data that may be interpreted to indicate a physiological condition of a person. For example, an image of a person's face may be captured by an image capture device (e.g., a digital still camera or video camera). The image may be analyzed by a computing device for identifying a facial expression of the person. The identified facial expression may be used for generating physiological indicator data for the person. In another example, a biometric measurement of a person may be determined by a suitable biometric device such as, but not limited to, retina scanners, fingerprint scanners, palm print readers, and the like. Physiological indicator data may be determined based on the biometric measurement. A biometric measurement may be any type of measurement indicative of a physical condition of a person, including, but are not limited to, a temperature measurement, perspiration measurement, galvanic skin responses, brain wave activity, heart rate, respiration, pupil dilation, and the like. In another example, physiological indicator data may be determined based on voice information acquired from a person. For example, the voice information may be used to determine a stress level of the person. The physiological indicator data may be determined based on the stress level. Further, for example, any biometric measurement, either alone or in combination, may be used for determining a stress level of a person. Another example physiological indicator data includes data relating to a gait of a person.

In another example, retail personnel and/or a workplace may be fitted with equipment to measure and/or infer arousal level (or stress level) or other physiological indicator (e.g., biometric devices to measure skin conductance, cameras, and the like). In another example, arousal and stress levels may be detected by less intrusive equipment, such as cameras or microphones. Other examples of indicators include, but are not limited to, facial expressions, movement, pacing, body language (e.g., arms crossed), changes in speech patterns, and the like. As referred to herein, the term “retail process analytics information” is generally information indicative of the recognition of meaningful patterns associated with retail processes and data. As an example, one or more computing devices within a retail environment may acquire, detect, or otherwise receive data associated with interactions among customers and/or retail personnel. This data may be acquired during the time of a known retail environment condition, such as during a purchase transaction of a customer or during some other interaction between a customer and retail personnel. Based on this data, retail process analytics information may be generated for presentation to a user. The retail process analytics may be generated based on physiological indicator data and an associated retail environment condition. Retail process analytics information may be present to a user via a user interface, such as a display of a computing device. Example retail process analytics information includes, but is not limited to, behavior performance information, retail personnel training information, advertising information, merchandising information, and the like. Information may be presented in the form of text and/or graphical data or indicia, such as charts and graphs.

The presently disclosed invention is now described in more detail. For example, FIG. 1 illustrates a block diagram of a purchase transaction system 100 according to embodiments of the present invention. The system 100 may be implemented in whole or in part in any suitable environment for conducting purchase transactions. For example, the system 100 may be implemented in a retail store having a variety of products or items for purchase and one or more POS terminals 102, security cameras 104, mobile computing devices 106, and server 108. Referring to FIG. 1, the POS terminals 102, security cameras 104, mobile computing devices 106, and server 108 may be communicatively connected via a communications network 110, which may be any suitable local area network (LAN), either wireless and/or wired. As an example, POS terminals 102, security cameras 104, mobile computing devices 106, and the server 108 may communicate data with one another via a WI-FI® connection. The system 100 may include other components, not shown, that are configured to acquire data within the retail environment, to process the data, and to communicate the data to the server 108

The components of the system 100 may each include hardware, software, firmware, or combinations thereof. For example, software residing on a data store of a respective component may include instructions implemented by a processor for carrying out functions disclosed herein. As an example, POS terminals 102 may each include a display (e.g., a touchscreen display), a barcode scanner, one or more user interfaces, and/or other equipment for conducting a purchase transaction for purchase of items by customers. A POS terminal 102 may be a self-checkout POS terminal or a retail personnel-assisted POS terminal. A POS terminal 102 may also include a suitable network interface for communicating with the network 110. Further, as an example, security cameras 102 may each include an image capture device or other hardware for capturing images or video. In addition, security cameras 102 may each include a suitable network interface for communicating captured image data and/or other data to the network 110. Mobile computing devices 106 may each include hardware (e.g., image capture devices, scanners, user interfaces, and the like) for capture of various data within the retail environment. Further, mobile computing devices 106 may each include a suitable network interface for communicating captured data to the network 110.

Data collected or otherwise acquired by POS terminals 102, security cameras 104, mobile computing devices 106, and/or other components of the system 100 may be communicated to the server 108 via the network 110 or another suitable technique. The server 108 may include a network interface 112 configured to communicate with the network 110 and to receive the data acquired by other components of the system 100. The server 108 may include an analytics module 114 configured to manage the received data, to analyze the data, and to generate retail process analytics information based on the data in accordance with embodiments of the present invention. As an example, FIG. 2 illustrates a flowchart of an example method for providing retail process analytics information based on physiological indicator data in accordance with embodiments of the present invention. The method of FIG. 2 is described as being implemented by the server 108 shown in FIG. 1, although the method may be implemented by any suitable computing device. The method may be implemented by hardware, software, and/or firmware of the server 108 and/or another computing device.

Referring to FIG. 2, the method includes receiving 200 physiological indicator data associated with a person. For example, components of the system 100 shown in FIG. 1 may collect various data throughout the retail environment. For example, POS terminals 102, security cameras 104, and mobile computing devices 106 may acquire images, video, sound recordings, and computer data, and subsequently communicate the data to the server 108. The data may be acquired by, for example, retail equipment, POS terminals or devices, image capture devices, computing devices, and the like. One or more of the system components may process the data for communication of only physiological indicator data to the server 108, and other system components may send raw data to the server 108 such that the server 108 can sort through the data to identify the physiological indicator data among the raw data.

The analytics module 114 may identify the physiological indicator data received via the network interface 112 and store the data in a memory 116. The analytics module 114 may be associated data received and stored with the system component that sent the data, and timestamp the data.

In an example, a security camera 104 may include an image capture device that captures video or images near its position within the retail environment. The capture video or images may be suitably processed by the security camera 104 and communicated to the server 108 via the network 110. The captured video or images may include physiological indicator data such as facial expressions of retail personnel or customers. Similarly, mobile computing devices 106 or other devices within the retail environment may acquire video or images and communicate the video or images to the server 108.

In another example, one of the system components, such as a POS terminal 102 or a mobile computing device 106, may include a biometric device configured to determine a biometric measurement of retail personnel or another person. For example, a biometric measurement may include, but is not limited to, scanning eye, palmprint, fingerprints, voice, and the like. The analytics module 114 may receive the biometric measurement and determine physiological indicator data based on the biometric measurement.

In another example, one of the system components, such as a POS terminal 102 or a mobile computing device 106, may include microphone equipment configured to record nearby sound, such as voice information of retail personnel, a customer, or another person. The analytics module 114 may receive the sound recording and determine physiological indicator data based on the biometric measurement. For example, the analytics module 114 may determine a stress level of either a customer or retail personnel based on voice information. Further, the analytics module 114 may determine physiological indicator data based on the determined stress level. As an example, voice information indicating a raised voice may indicate a high level of stress.

In another example, a physiological indicator data can be determined based on a facial expression in an image. For example, the analytics module 114 may receive a captured image of a face of either a customer or retail personnel. Further, the analytics module 114 may identify a facial expression of the face within the captured image. The analytics module 114 may subsequently determine physiological indicator data based on the facial expression. For example, the face may be identified and analyzed to determine whether the person is smiling or frowning. A high stress level may be inferred if it is determined that the person is frowning. In contrast, a low stress level may be inferred if it is determined that the person is smiling.

The method of FIG. 2 includes determining 202 one or more retail environment conditions at a time associated with the physiological indicator data. For example, the analytics module 114 can determine a retail environment condition based on one or more images. The images may have been captured by components of the system 100 and communicated to the server 108.

In another example, a retail environment condition may be determined based on captured images. For example, the analytics module 114 may receive one or more images from a system component, such as a POS terminal 102 or a mobile computing device 106. For example, an image may be captured by a POS terminal 102 having a known location. The analytics module 114 may determine the location of the image based on the known location of the POS terminal 102. The area of the POS terminal 102 may be categorized based on its location or area. In this example, the category of the area may be a customer/employee interaction station. The analytics module 114 may determine the retail environment condition based on the categorized area. In another example, an area of a security camera 104 may be considered a security camera area. In this way, the analytics module 114 can determine a probably interaction based on the category. For example, the analytics module 114 may determine that the retail environment condition of a retail personnel and customer interaction occurs in an area of a POS terminal 102.

The method of FIG. 2 includes generating 204 retail process analytics information for presentation based on the physiological indicator data and the retail environment condition. For example, the analytics module 114 may generate advertisement analytics information and/or retail personnel analytics information based on physiological indicator data and a retail environment condition. The physiological indicator data may be associated with expectation. For example, it can be determined whether the combination of store environment, interaction with associates, advertisement, the like, or combinations thereof eventually lead to a sale.

In an example, retail process analytics information may be generated based weather data. For example, the weather data may be suitably obtained by the server 108 via the Internet. The weather data may be used along with physiological indicator data and/or a retail environment condition for determining retail process analytics information. Such data may be used as a predictor for appropriate relationship for physiological arousal between associate and shopper. For example, on rainy days, it can be determined whether retail personnel should make an effort to be happier to consumers.

In another example, the analytics module 114 may use physiological indicator data, retail environment condition, and/or other information for generating behavior performance information, retail personnel training information, advertising information, merchandising information, or the like. Performance data (i.e, how well an associate is maximizing expectation) can be correlated with the relationship for physiological arousal between associate and shopper to instruct associates on whether they should, for example, act “happier”, take breaks every so often, and the like.

The method of FIG. 2 includes presenting 206 the retail process analytics information to a user. Such information may be used by management personnel or other retail personnel for helping retail personnel, such as salespeople, to improve performance. Information may be presented, for example, via smartphone, any suitable display, POS equipment, and the like. In an example, the information may be presented by text and/or graphical data or indicia, such as charts and graphs, via a user interface, such as a user interface 118 of the server 108.

In accordance with embodiments of the present invention, FIG. 3 illustrates a flowchart of another example method for providing retail process analytics information based on physiological indicator data in accordance with embodiments of the present invention. The method of FIG. 3 is described as being implemented by the server 108 shown in FIG. 1, although the method may be implemented by any suitable computing device. The method may be implemented by hardware, software, and/or firmware of the server 108 and/or another computing device.

Referring to FIG. 3, the method includes determining 300 physiological indicator data associated with an interaction between a customer and retail personnel within a retail environment. For example, physiological indicator data may be received from one or more components of the system 100. More particularly, for example, physiological indicator data may be determined by the analytics module 114 based on one or more images received from a POS terminal 102, a security camera 104, or a mobile computing device 106. In another example, a captured image may include a face of one or both of a customer and retail personnel. The analytics module 114 may identify a facial expression on face(s) in the image, and determine a physiological indicator data based on the facial expression. As an example, tired and stressed retail personnel may convey their stress to a customer through facial expressions, perhaps reducing a likelihood of sale or satisfaction of a customer. In another example, physiological indicator data may be determined based on voice information, a determined stress level, and/or other data in accordance with examples disclosed herein.

The method of FIG. 3 includes generating 302 retail process analytics information for user presentation based on the physiological indicator data. For example, the analytics module 114 may generate retail process analytics information based on the physiological indicator data.

The method of FIG. 3 includes presenting 304 the retail process analytics information to a user. Information may be presented, for example, via smartphone, any suitable display, POS equipment, or the like. In an example, the information may be presented by text and/or graphical data or indicia, such as charts and graphs, via a user interface, such as a user interface 118 of the server 108.

In accordance with embodiments of the present invention, FIG. 4 illustrates a flowchart of another example method for providing retail process analytics information based on physiological indicator data in accordance with embodiments of the present invention. The method of FIG. 4 is described as being implemented by the server 108 shown in FIG. 1, although the method may be implemented by any suitable computing device. The method may be implemented by hardware, software, and/or firmware of the server 108 and/or another computing device.

Referring to FIG. 4, the method includes determining 400 physiological indicator data associated with an interaction between a customer and an advertisement within a retail environment. For example, physiological indicator data may be received from one or more components of the system 100. More particularly, for example, physiological indicator data may be determined by the analytics module 114 based on one or more images received from a POS terminal 102, a security camera 104, or a mobile computing device 106. In another example, a captured image may include a face of a customer in an area of an advertisement or merchandising material. The analytics module 114 may identify a facial expression on the face in the image, and determine a physiological indicator data based on the facial expression. In another example, physiological indicator data may be determined based on voice information, a determined stress level, and/or other data in accordance with examples disclosed herein. In another example, a biometric measurement may be used to determine a physiological indicator data. In another example, voice information may be used to determine a physiological indicator data in accordance with examples disclosed herein.

The method of FIG. 4 includes generating 402 retail process analytics information for user presentation based on the physiological indicator data. For example, the analytics module 114 may generate retail process analytics information based on the physiological indicator data. Analytics may be generated, for example, by examining the relationship between performance (i.e., maximized expectation) and physiological arousal (e.g., the absolute physiological arousal of the associate; the relative arousal of the associate compared to the shopper), along with other factors (e.g., time of day, day of week, day of month, holiday; weather).

The method of FIG. 4 includes presenting 404 the retail process analytics information to a user. Such information may be used by management personnel or other retail personnel for improving advertising and merchandising with the retail environment. Information or data about customer reaction to advertising and merchandising may be presented to retail personnel to ensure that the advertisement elicits an optimum or desired response for customers. As an example, a customer approaching a kiosk may show an interested look, walk more quickly, or provide some other indicator of interest in the kiosk. Information may be displayed via smartphone, any suitable display, POS equipment, or the like. In an example, the information may be presented by text and/or graphical data or indicia, such as charts and graphs, via a user interface, such as a user interface 118 of the server 108.

In accordance with embodiments of the present invention, FIG. 5 illustrates a flowchart of another example method for providing retail process analytics information based on physiological indicator data in accordance with embodiments of the present invention. The method of FIG. 5 is described as being implemented by the server 108 shown in FIG. 1, although the method may be implemented by any suitable computing device. The method may be implemented by hardware, software, and/or firmware of the server 108 and/or another computing device.

Referring to FIG. 5, the method includes receiving 500 physiological indicator data associated with first and second persons. For example, the data may be associated with multiple different people, such as a couple or family interacting with one or more retail personnel. For example, a security camera 104 or another computing device within the retail environment may acquire images or video of a customer and retail personnel within a retail environment. In another example, voice information may be acquired of a customer and retail personnel. One or more of the system components may process the data for communication of only physiological indicator data to the server 108, and other system components may send raw data to the server 108 such that the server 108 can sort through the data to identify the physiological indicator data among the raw data.

The method of FIG. 5 includes identifying 502 one of the first and second persons as being retail personnel. For example, the analytics module 114 may use the data to identify one of the persons as being retail personnel. The analytics module 114 may, for example, compare a verified image of retail personnel to an acquired image to determine that the person in the acquired image is the retail personnel. In this way, the physiological indicator data may be associated with personnel information, such as communication information, associated with the retail personnel.

The method of FIG. 5 includes generating 504 retail process analytics information for user presentation based on the physiological indicator data. For example, the analytics module 114 may generate retail personnel analytics information based on physiological indicator data and a retail environment condition. Analytics may be generated, for example, by examining the relationship between performance (i.e., maximized expectation) and physiological arousal (e.g., the absolute physiological arousal of the associate; the relative arousal of the associate compared to the shopper), along with other factors (e.g., time of day, day of week, day of month, holiday; weather).

In accordance with embodiments of the present invention, the retail personnel analytics information may include feedback data and information for presentation to the identified retail personnel. This information can be used by the retail personnel for assessing his or her interaction with the customer. Further, for example, the information can be provided to the retail personnel in real-time so that he or she can adjust his or her interaction with the customer based on the information. In another example, the information provided to the retail personnel may provide suggestions for actions to implement. For example, the information may suggest that the retail personnel take a break, utilize a relaxation technique, or the like in order to adjust his or her arousal level or stress level.

Example suggestions may include recommendations for long-term changes to generally improve physical health, psychological health, and/or the like in order to improve mood (and better regulate physiological arousal).

The method of FIG. 5 includes presenting 506 the retail process analytics information at a computing device associated with the person identified as the retail personnel. For example, the analytics module 114 may control the network interface 112 to communicate the retail process analytics information to a computing device associated with the retail personnel. The computing device of the retail personnel may subsequently present the information. For example, the information may be presented via a display.

Feedback provided to retail personnel can be changed based on an examination of a relationship between performance (i.e., maximized expectation) and physiological arousal (e.g., the absolute physiological arousal of the associate; the relative arousal of the associate compared to the shopper), along with other factors (e.g., time of day, day of week, day of month, holiday; weather). This may occur in real-time by measuring signs that expectation is increasing (i.e., observable or detectable signs that a shopper is becoming more likely to purchase and/or more likely to purchase more). If expectation is decreasing, feedback could be given to either increase or decrease physiological arousal based upon past information, retailer hypotheses about the most appropriate matches between arousal/stress levels, and the like.

Over time, retailers may analyze data to determine which absolute and relative arousal/stress levels are associated with increased expectation. In an example, if a retailer finds that the optimal arousal level is (e.g., shopper arousal level+2) and an associate is demonstrating an arousal level equal to the shopper's arousal level, the system may recommend actions to raise both the associate's arousal level and the shopper's perception of the associate's arousal level. In another example, asking certain questions or moving to a particular distance from the shopper can increase the perceived arousal (i.e., interest, engagement) level of an associate.

In accordance with embodiments of the present invention, a customer may interface with a computing device within a retail environment. For example, the customer may interface with a kiosk computing device. Physiological indicator data may be acquired from the customer by the kiosk computing device and/or other computing devices in accordance with examples disclosed herein. The data may be communicated to the server 108, and the analytics module 112 may analyze the data to generate retail process analytics information based on the data. This information may be used for altering or adjusting interface of the kiosk computing device with the customer. For example, an avatar presented to the customer at the kiosk computing device may change expressions or use different wording based on the information.

In accordance with embodiments of the present invention, retail process analytics information may be used for assessing performance of a retail personnel or effectiveness of an advertisement within a retail environment. The information may indicate stress of retail personnel within a particular retail environment condition. There is an empirical relationship between stress and performance, and the presented information may indicate an optimal range of stress for performance of a task within the retail environment. In addition, the information may indicate optimal retail environment conditions for achieving the optimal range of stress for retail personnel.

In accordance with embodiments of the present invention, mobile computing devices, cameras, galvanic skin response sensors, and the like may be used for detecting arousal or stress levels of retail personnel, such as salespeople, for assisting them to perform optimally during sales. For example, if a salesperson is near his or her quota near the end of sales cycle, he or she may be too excited or stressed to optimally interact with a particular customer. Data on closure rates may be combined with arousal levels or other physiological measures to predict optimal arousal or stress level for presentation to a user. This information may also be combined with other data, such as, but not limited to, promotions, store location, or time of day.

In accordance with embodiments of the present invention, physiological indicator data may be combined with past transactional and sales data to indicate optimal levels of arousal for retail personnel. For example, data on closure rates may be combined with physiological indicator data and other relevant data (e.g., promotions, store location, and time of day) to predict performance, influence training and store design decisions, optimize scheduling and operations, and the like. Further, for example, similar techniques may be used to determine if a customer is experiencing frustration, boredom, or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
using a processor and memory for:
receiving physiological indicator data associated with a person;
determining a retail environment condition at a time associated with the physiological indicator data; and
generating retail process analytics information for user presentation based on the physiological indicator data and the retail environment condition.

2. The method of claim 1, wherein receiving physiological indicator data comprises receiving the physiological indicator data from one of retail equipment, a point-of-sale (POS) device, an image capture device, and a computing device.

3. The method of claim 1, further comprising receiving one or more images captured within a retail environment, and
wherein determining a retail environment condition comprises determining the retail environment condition based on the one or more images.

4. The method of claim 3, further comprising categorizing one or more areas where the one or more images were captured, and
wherein determining a retail environment condition comprises determining the retail environment condition based on the categorized one or more areas.

5. The method of claim 1, further comprising:
receiving a captured image of a face of one of a customer and retail personnel within a retail environment;
identifying a facial expression of the face within the captured image; and
determining the physiological indicator data based on the facial expression.

6. The method of claim 1, further comprising:
receiving a biometric measurement of retail personnel at the time; and
determining the physiological indicator data based on the biometric measurement.

7. The method of claim 6, further comprising using a biometric device to determine the biometric measurement of the retail personnel.

8. The method of claim 1, further comprising:
receiving voice information of one of a customer and retail personnel at the time;
determining a stress level of the one of the customer and retail personnel based on the voice information; and
determining the physiological indicator data based on the determined stress level.

9. The method of claim 1, wherein generating retail process analytics information comprises generating one of advertisement analytics information and retail personnel analytics information based on the physiological indicator data and the retail environment condition.

10. The method of claim 1, further comprising receiving one of weather data and time of day information, and
wherein generating retail process analytics information comprises generating the retail process analytics information based on the one of weather data and time of data information.

11. The method of claim 1, wherein generating retail process analytics information comprises generating one of behavior performance information, retail personnel training information, advertising information, and merchandising information.

12. The method of claim 1, further comprising presenting the retail process analytics information to a user.

13. A method comprising:
using a processor and memory for:
determining physiological indicator data associated with an interaction between a customer and retail personnel within a retail environment; and
generating retail process analytics information for user presentation based on the physiological indicator data.

14. The method of claim 13, further comprising receiving the physiological indicator data from one or more computing devices within the retail environment.

15. The method of claim 13, further comprising receiving the physiological indicator data from one of retail equipment, a point-of-sale (POS) device, an image capture device, and a computing device.

16. The method of claim 13, further comprising receiving one or more images captured within the retail environment, and
wherein determining physiological indicator data comprises determining the physiological indicator data based on the one or more images.

17. The method of claim 13, further comprising:
receiving a captured image of a face of one of the customer and retail personnel within the retail environment;
identifying a facial expression of the face within the captured image; and
determining the physiological indicator data based on the facial expression.

18. The method of claim 13, further comprising:
receiving a biometric measurement of the retail personnel at a time of the interaction; and
determining the physiological indicator data based on the biometric measurement.

19. The method of claim 18, further comprising using a biometric device to determine the biometric measurement of the retail personnel.

20. The method of claim 19, further comprising:
receiving voice information of one of the customer and retail personnel at a time of the interaction;
determining a stress level of the one of the customer and retail personnel based on the voice information; and
determining the physiological indicator data based on the determined stress level.

21. The method of claim 13, wherein generating retail process analytics information comprises generating one of advertisement analytics information and retail personnel analytics information based on the physiological indicator data.

22. The method of claim 13, wherein generating retail process analytics information comprises generating one of behavior performance information, retail personnel training information, advertising information, and merchandising information.

23. The method of claim 13, further comprising presenting the retail process analytics information to a user.

24. A method comprising:
using a processor and memory for:
determining physiological indicator data associated with an interaction between a customer and an advertisement within a retail environment; and
generating retail process analytics information for user presentation based on the physiological indicator data.

25. The method of claim 24, further comprising receiving the physiological indicator data from one or more computing devices within the retail environment.

26. The method of claim 24, further comprising receiving the physiological indicator data from one of retail equipment, a point-of-sale (POS) device, an image capture device, and a computing device.

27. The method of claim 24, further comprising receiving one or more images captured within the retail environment, and
wherein determining physiological indicator data comprises determining the physiological indicator data based on the one or more images.

28. The method of claim 24, further comprising:
receiving a captured image of a face of the customer within the retail environment at a time of the interaction;
identifying a facial expression of the face within the captured image; and
determining the physiological indicator data based on the facial expression.

29. The method of claim 24, further comprising:
receiving a biometric measurement of the customer at a time of the interaction; and
determining the physiological indicator data based on the biometric measurement.

30. The method of claim 29, further comprising using a biometric device to determine the biometric measurement of the customer.

31. The method of claim 24, further comprising:
receiving voice information of the customer at a time of the interaction;
determining a stress level of the customer based on the voice information; and
determining the physiological indicator data based on the determined stress level.

32. The method of claim 24, wherein generating retail process analytics information comprises generating advertisement analytics information based on the physiological indicator data.

33. The method of claim 24, wherein generating retail process analytics information comprises generating one of advertising information and merchandising information.

34. The method of claim 24, further comprising presenting the retail process analytics information to a user.

35. A computing device comprising:
a processor and memory; and
an analytics module configured to:
receive physiological indicator data associated with a person;
determine a retail environment condition at a time associated with the physiological indicator data; and
generate retail process analytics information for user presentation based on the physiological indicator data and the retail environment condition.

36. A computing device comprising:
a processor and memory; and
an analytics module configured to:
determine physiological indicator data associated with an interaction between a customer and retail personnel within a retail environment; and
generate retail process analytics information for user presentation based on the physiological indicator data.

37. A computing device comprising:
a processor and memory; and
an analytics module configured to:
determine physiological indicator data associated with an interaction between a customer and an advertisement within a retail environment; and
generate retail process analytics information for user presentation based on the physiological indicator data.

38. A computer program product for providing retail process analytics information, said computer program product comprising:
a non-transitory computer readable storage medium having computer readable program code embodied therewith, the computer readable program code comprising:
computer readable program code configured to receive physiological indicator data associated with a person;
computer readable program code configured to determine a retail environment condition at a time associated with the physiological indicator data; and
computer readable program code configured to generate retail process analytics information for user presentation based on the physiological indicator data and the retail environment condition.

39. A computer program product for providing retail process analytics information, said computer program product comprising:
a non-transitory computer readable storage medium having computer readable program code embodied therewith, the computer readable program code comprising:
computer readable program code configured to determine physiological indicator data associated with an interaction between a customer and retail personnel within a retail environment; and
computer readable program code configured to generate retail process analytics information for user presentation based on the physiological indicator data.

40. A computer program product for providing retail process analytics information, said computer program product comprising:
a non-transitory computer readable storage medium having computer readable program code embodied therewith, the computer readable program code comprising:
computer readable program code configured to determine physiological indicator data associated with an interaction between a customer and an advertisement within a retail environment; and
computer readable program code configured to generate retail process analytics information for user presentation based on the physiological indicator data.
